(19) United States
(12) Patent Application Publication
(10) Pub. No.: US 2002/0195933 A1
(43) Pub. Date: Dec. 26, 2002

(54) Electroluminescent element having thin film transparent electrode

(76) Inventors: Mitsuru Saito, Miyagi-ken (JP); Takahiro Shikamo, Miyagi-ken (JP); Masaharu Takenaka, Miyagi-ken (JP)

Correspondence Address: BEYER WEAVER & THOMAS LLP, P.O. BOX 778, BERKELEY, CA, 94704-0778, US

(21) Appl. No.: 10/165,678

(22) Filed: Jun. 6, 2002

(30) Foreign Application Priority Data
Jun. 25, 2001 (JP) 2001-191900

(51) Int. Cl. H05B 33/00

(52) U.S. Cl. 313/509

(57) ABSTRACT

An insulating portion formed to insulate a transparent electrode and a reverse side electrode from each other, in order to form an electrode terminal for applying a voltage between the transparent electrode and the reverse side electrode, wherein the transparent electrode is formed by a thin film producing technique such as vapor deposition or sputtering, is composed by partly removing the transparent electrode, which removal is performed by irradiation with a laser beam.

### BACKGROUND OF THE INVENTION

1. Field of the Invention

The present invention relates to an electroluminescent element, and more particularly to an insulating structure for insulating a lead conductor communicating with a reverse side electrode from a transparent electrode.

2. Description of the Prior Art

Electroluminescent elements are extensively used for illuminating and displaying on display units provided on electronic devices including mobile telephones and laptop computers.

FIG. 6 and FIG. 7 illustrate a prior art regarding such an electroluminescent element, in which a transparent electrode 22 is formed over the back face of an insulating transparent film 21, a fluorescent layer 23 over the back face of the transparent electrode 22 and, recessed inward from one edge 21a of the transparent film 21, a dielectric layer 24, a reverse side electrode 25 and a resist layer 26 are laminated in this order over the back face of the fluorescent layer 23.

Between the fluorescent layer 23 and the edge 21a of the transparent film 21 is formed an insulating portion 27 by partly extending the dielectric layer 24 to form an electrode terminal for applying a voltage between the transparent electrode 22 and the reverse side electrode 25. Part of the reverse side electrode 25 is extended over the rear face of this insulating portion 27 to constitute a first lead conductor 28, which is one electrode of the electrode terminal, and part of the transparent electrode 22 exposed from the insulating portion 27 constitutes a second lead conductor 29, which is the other electrode of the electrode terminal. Though not shown, to ensure insulation between the transparent electrode 22 and the first lead conductor 28, it is advisable to provide another insulation layer on the under side in the illustration (surface side) of the insulating portion 27 consisting of the extended part of the dielectric layer 24.

Over the back face of the transparent film 21 are arranged a pair of terminals 30 and 30, and the tips of these paired terminals 30 and 30 are connected to the first and second lead conductors 28 and 29 by a tacky sheet 31.

The conventional electroluminescent element configured as described above is used in a state in which it is incorporated into any of the electronic devices mentioned above and the pair of terminals 30 and 30 are connected to a wiring board within. When a prescribed A.C. pulse voltage is applied from a drive circuit mounted on this wiring board to between the transparent electrode 22 and the reverse side electrode 25 via the pair of terminals 30 and 30 and the first and second lead conductors 28 and 29, the fluorescent layer 23 fluoresces, and this fluorescence is emitted outside the electroluminescent element from the reverse side to the rear face (i.e. the front face) of the transparent film 21.

However, in the electroluminescent element according to the prior art, the procedure to connect the wiring board of the electronic device with the pair of terminals 30 and 30 by soldering is extremely complex and involves many man-hours, inviting a problem of pushing up the production cost of the electronic device.

This problem could be solved by removing the pair of terminals 30 and 30 and instead providing on the wiring board of the electronic device a connector to which the outer part of the fluorescent layer 23 toward the edge 21a of the electroluminescent element can be connected and connecting the electroluminescent element with the wiring board by this connector. However, in this arrangement, as shown in FIG. 8, the compressive force of a power feed terminal 13 of the connector may crush the insulating portion 27 arranged intervening between the first lead conductor 28 and the transparent electrode 22 to insulate the reverse side electrode 25 and the transparent electrode 22 from each other, cancel the electrical insulation between the first lead conductor 28 and the transparent electrode 22, and thereby invite short-circuiting of the reverse side electrode 25 and the transparent electrode 22.

### SUMMARY OF THE INVENTION

An object of the present invention, attempted to solve the problems with the prior art noted above, is to provide a highly reliable electroluminescent element which can facilitate connecting work and securely prevent short-circuiting between a reverse side electrode and a transparent electrode.

In order to achieve the object stated above, an electroluminescent element according to the invention is most significantly characterized by its configuration comprising an insulating transparent film, a transparent electrode formed over a back face of the transparent film, a fluorescent layer formed over a back face of the transparent electrode, a dielectric layer formed over a back face of the fluorescent layer, a reverse side electrode formed over a back face of the dielectric layer, and an electrode terminal for applying a voltage between the transparent electrode and the reverse side electrode to cause the fluorescent layer to fluoresce, wherein the transparent electrode is formed by a thin film producing technique such as vapor deposition or sputtering, and an insulating portion formed to insulate the transparent electrode and the reverse side electrode from each other to form the electrode terminal is composed by removing the transparent electrode.

In the configuration described above, the electrode terminal may have a first lead conductor communicating with the reverse side electrode and a second lead conductor communicating with the transparent electrode, with the first lead conductor and the second lead conductor being arranged within the insulating portion at a prescribed distance from each other.

In the configuration described above, the first lead conductor may be formed of the same material as that of the reverse side electrode by printing.

In the configuration described above, the first and second lead conductors may be formed of a laminated film of a silver layer and a carbon layer in the descending order of distance to the transparent film and arranged in conjunction over the insulating portion.

In the configuration described above, the insulating portion may be formed by partially removing the transparent electrode by irradiation with a laser beam.

### BRIEF DESCRIPTION OF THE DRAWINGS

FIG. 1 is a plan of an electroluminescent element in a mode of implementing the present invention, with its resist layer cut in to show the structure;

FIG. 2 shows a section along line 2-2 in FIG. 1;

FIG. 3 illustrates a section of a first lead conductor provided in the electroluminescent element;

FIG. 4 illustrates a section of a second lead conductor provided in the electroluminescent element;

FIG. 5 is a plan of an electroluminescent element in another mode of implementing the present invention;

FIG. 6 shows an exploded perspective view of an electroluminescent element according to the prior art;

FIG. 7 shows a section along line 7-7 in FIG. 6; and

FIG. 8 is a section illustrating problems with an electroluminescent element according to the prior art.

### DETAILED DESCRIPTION OF THE PREFERRED EMBODIMENT

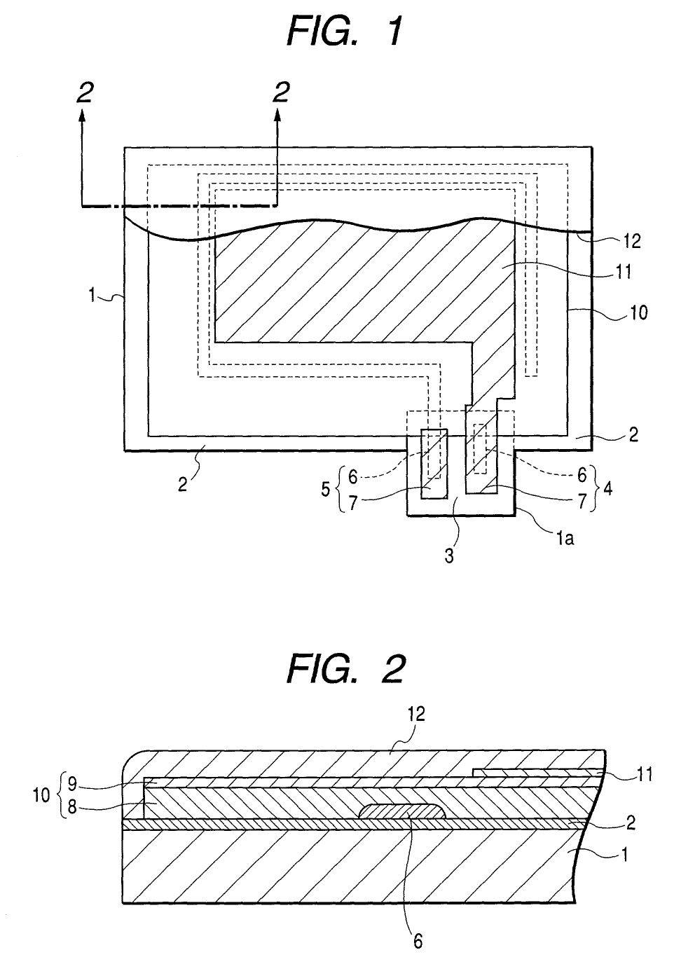

An electroluminescent element in one mode of carrying out the present invention will be described below with reference to FIG. 1 through FIG. 4.

As shown in FIG. 1 through FIG. 4, the electroluminescent element according to the present invention is provided with a rectangular transparent film 1 from one of whose ends a tongue 1a protrudes. This transparent film 1 consists of an insulating transparent material such as polyethylene phthalate (PET).

Over the back face of the transparent film 1 is formed a transparent electrode 2, and an insulating portion 3 is formed by removing part of the transparent electrode 2 present over the back face of the tongue 1a so as to somewhat invade inside the transparent film 1. The transparent electrode 2 is formed of indium tin oxide (ITO) by a thin film producing technique such as vapor deposition or sputtering, and the partial removal of the transparent electrode 2 to form the insulating portion 3 is accomplished by dry etching, which involves irradiation with a laser beam such as YAG laser.

In the part inside the insulating portion 3 matching the tongue 1a, there are arranged in conjunction a first lead conductor 4, which is one electrode of the electrode terminal, for applying a voltage to between the transparent electrode 2 and a reverse side electrode 11 to be described afterwards and a second lead conductor 5, which is the other electrode of the electrode terminal, and these first and second lead conductors 4 and 5 are configured of a laminated structure consisting of two layers including a silver layer 6 and a carbon layer 7 covering it. The Carbon layer 7 of the first lead conductor 4 is extended and connected to the reverse side electrode 11 to be described afterwards, and the Silver layer 6 of the second lead conductor 5 extends along the outer edge of the transparent film 1 over the back face of the transparent electrode 2 (incidentally in FIG. 1, the Carbon layer 7 and the reverse side electrode 11 are shadowed).

The Silver layer 6 constituting these first and second lead conductors 4 and 5 is formed by applying (printing with) silver paste, and the Carbon layer 7 is formed by applying ink paste consisting of stirred mixture of carbon powder and binder resin.

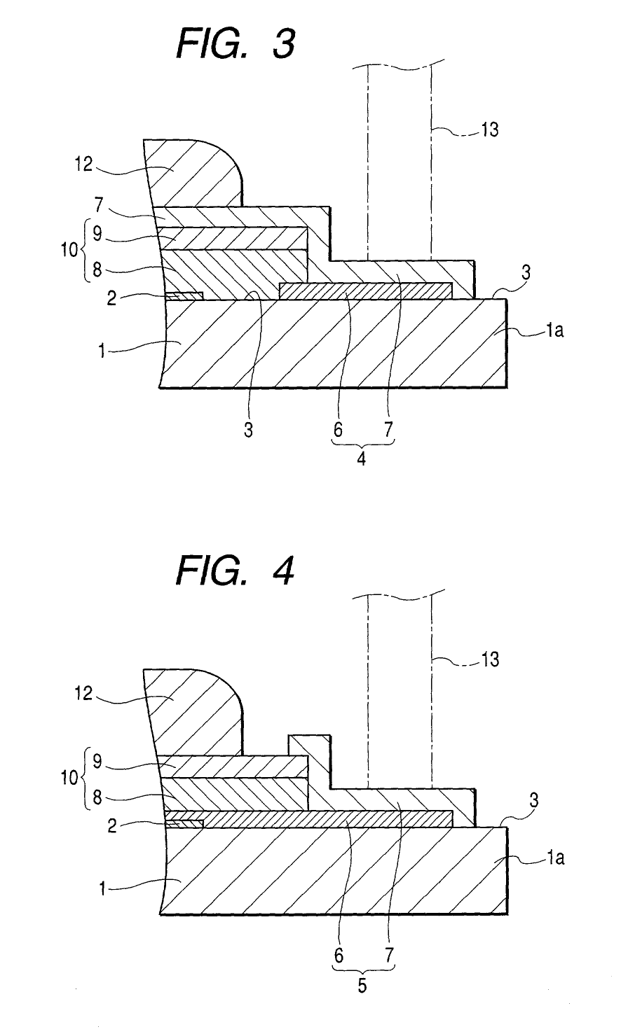

Over the back face of the transparent electrode 2 is formed of a multi-layered film 10 structured by successively stacking a fluorescent layer 8 and a dielectric layer 9. As shown in FIG. 3 through FIG. 4, part of it is formed to be positioned within the insulating portion 3 receding inward from the end of the transparent film 1 where the tongue 1a is formed.

The fluorescent layer 8 is formed by applying ink paste consisting of stirred mixture of binder resin and fluorescent powder prepared by doping zinc sulfide (ZnS) with Mn, Cu, Cl and the like, and the dielectric layer 9 is formed by applying ink paste consisting of stirred mixture of binder resin and barium titanate (BaTiO₃) powder.

Over the back face of the multi-layered film 10 is formed the reverse side electrode 11 so as to leave the peripheral part of the multi-layered film 10 exposed. This reverse side electrode 11 is formed by applying the same ink paste as the material of the aforementioned Carbon layer 7 constituting the first and second lead conductors 4 and 5, and this Carbon layer 7 is formed over the back face of not only the reverse side electrode 11 but also the Silver layer 6 of the first and second lead conductors 4 and 5.

Over the back face of the reverse side electrode 11 is formed a resist layer 12 to cover the aforementioned peripheral part of the multi-layered film 10. This resist layer 12 is formed by applying an insulating resin material.

The operation of the electroluminescent element in this mode of implementing the invention, configured as stated above, will be described below.

This electroluminescent element, incorporated into any of the electronic devices referred to in the description of the prior art, is used in a state in which the tongue 1a is inserted into a connector (not shown) provided on a wiring board within the device and thereby connected to the wiring board. When a prescribed A. C. pulse voltage is applied from this wiring board to between the transparent electrode 2 and the reverse side electrode 11 via the connector and the first and second lead conductors 4 and 5, the fluorescent layer 8 fluoresces, and the fluorescence is emitted outside the electroluminescent element from the reverse side to the rear face (i.e. the front face) of the transparent film 1.

In this electroluminescent element, as connection to the wiring board can be established by merely inserting the tongue 1a to the connector, the connecting work can be simplified. Moreover, as the insulating portion 3 for insulating the first lead conductor 4 from the transparent electrode 2 is configured of part of the insulating transparent film 1 formed by removing the transparent electrode 2, it is possible to securely prevent the suppressive force of the power feed terminal 13 provided in the connector for applying the A.C. pulse voltage from canceling the electrical insulation between the first lead conductor 4 and the transparent electrode 2 and thereby short-circuiting the reverse side electrode 11 and the transparent electrode 2.

Moreover, since the first and second lead conductors 4 and 5 are configured of a laminated film consisting of two layers including the Silver layer 6 and the Carbon layer 7 covering it, the Carbon layer 7 can prevent the first and second lead conductors 4 and 5 from being worn by their sliding contact with the power feed terminal 13, and at the same time the Silver layer 6 can reduce the continuity resistance between the first and second lead conductors 4 and 5.

Since the reverse side electrode 11 is configured of the same material as the Carbon layer 7 as stated above, after the insulating portion 3 is formed and the Silver layer 6 and the multi-layered film 10 are successively formed, the reverse side electrode 11 can be simultaneously formed by coating at the same step of the manufacturing process as the Carbon layer 7, and accordingly the manufacturing process can be simplified to further reduce the cost.

Further, as the transparent electrode 2 is formed by a thin film producing technique such as vapor deposition or sputtering, it is possible to easily form the insulating portion 3 by irradiation with a laser beam, to form the insulating portion 3 more quickly than by removal using an organic solvent where the transparent electrode 2 is formed by printing and, at the same time, to use an inexpensive commercially available transparent film with a transparent electrode.

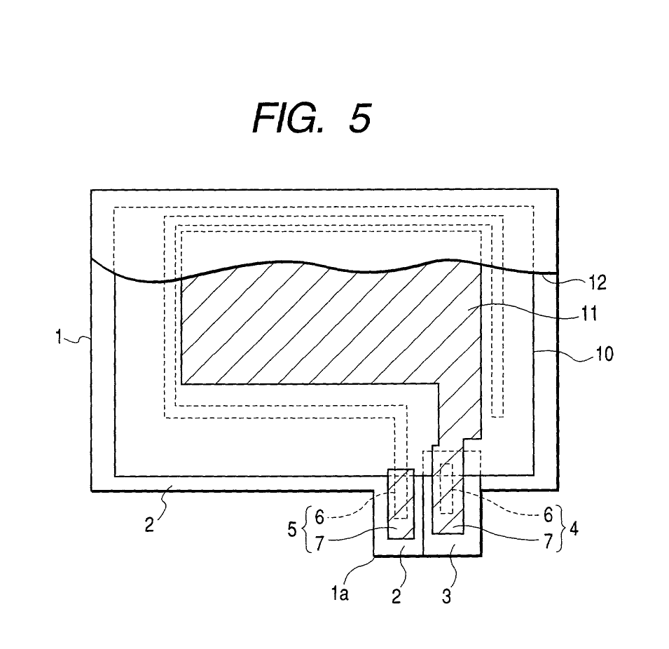

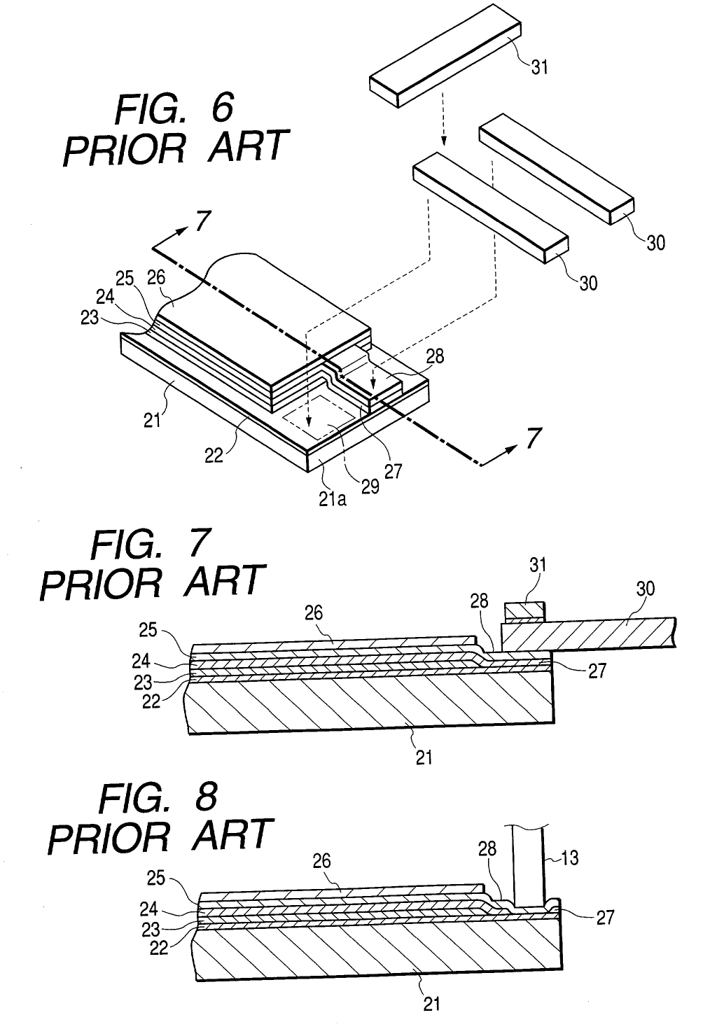

To add, though in this mode of implementation the part of the transparent electrode 2 present over the back face of the tongue 1a is supposed to be wholly removed in order to prevent the load generating when the tongue 1a is fitted to the connector from giving rise to a crack in the transparent electrode 2 and thereby adversely affecting its electrical conductivity, it is also acceptable to form the insulating portion 3 by removing only partially the segment of the transparent electrode 2 over the back face of the tongue 1a as shown in FIG. 5, and to form the first lead conductor 4 in this insulating portion 3 and the second lead conductor 5 in the rest of the transparent electrode 2. In this case as well, short-circuiting between the reverse side electrode 11 and the transparent electrode 2 can be securely prevented.

The present invention implemented in the mode described above provides the following advantages.

Since the electroluminescent element according to the invention has a configuration in which an insulating portion to insulate a transparent electrode and a reverse side electrode for the purpose of forming an electrode terminal to apply a voltage to between the transparent electrode and the reverse side electrode is formed by removing the transparent electrode, its connection to the wiring board of an electronic device can be easily accomplished, and it is possible to securely prevent the suppressive force of the power feed terminal or the like from short-circuiting the reverse side electrode and the transparent electrode. Also, as the electrode terminal is configured of a first lead conductor communicating with the reverse side electrode and a second lead conductor communicating with the transparent electrode, and the first lead conductor and the second lead conductor are arranged at a prescribed distance to each other within the insulating portion, it is possible to prevent any crack from arising in the transparent electrode and adversely affecting its electrical conductivity.

Also, as the first lead conductor is formed of the same material as that of the reverse side electrode and accordingly the reverse side electrode and the first lead conductor can be simultaneously formed at the same step of the manufacturing process, the manufacturing process can be simplified to further reduce the cost.

Also, as the first and second lead conductor are configured of a laminated film consisting of a silver layer and a carbon layer in a descending order of distance to the transparent film, the first and second lead conductors can be prevented from being worn and the continuity resistance can be kept low.

Further, as the insulating portion is formed by partially removing the transparent electrode by irradiation with a laser beam, the insulating portion can be formed easily and quickly.

What is claimed is:

1. An electroluminescent element provided with an insulating transparent film, a transparent electrode formed over a back face of the transparent film, a fluorescent layer formed over a back face of the transparent electrode, a dielectric layer formed over a back face of the fluorescent layer, a reverse side electrode formed over a back face of the dielectric layer, and an electrode terminal for applying a voltage between the transparent electrode and the reverse side electrode to cause the fluorescent layer to fluoresce, wherein the transparent electrode is formed by a thin film producing technique such as vapor deposition or sputtering, and wherein an insulating portion formed to insulate the transparent electrode and the reverse side electrode from each other to form the electrode terminal is composed by removing the transparent electrode.

2. The electroluminescent element according to claim 1, wherein the electrode terminal has a first lead conductor communicating with the reverse side electrode and a second lead conductor communicating with the transparent electrode, and wherein the first lead conductor and the second lead conductor are arranged within the insulating portion at a prescribed distance from each other.

3. The electroluminescent element according to claim 1, wherein the first lead conductor is formed of the same material as that of the reverse side electrode by printing.

4. The electroluminescent element according to claim 2, wherein the first and second lead conductors are formed of a laminated film of a silver layer and a carbon layer in a descending order of distance to the transparent film and arranged in conjunction over the insulating portion.

5. The electroluminescent element according to claim 1, wherein the insulating portion is formed by partially removing the transparent electrode by irradiation with a laser beam.
